(19) United States
(12) Patent Application Publication
(10) Pub. No.: US 2016/0136797 A1
(43) Pub. Date: May 19, 2016

(54) DRIVING TOOL FOR DRIVING FASTENING MEANS INTO A WORKPIECE

(71) Applicant: ILLINOIS TOOL WORKS INC., Glenview, IL (US)

(72) Inventors: Torsten WEIGMANN, Ronnenberg (DE); Klaus VON SOEST, Winzenburg (DE); Olaf HAEHNDEL, Plattensen (DE)

(21) Appl. No.: 14/898,212

(22) PCT Filed: Apr. 23, 2014
(86) PCT No.: PCT/US14/35108

§ 371 Date: Dec. 14, 2015

(30) Foreign Application Priority Data
Jun. 25, 2013 (DE) 10 2013 106 658.5

(51) Int. Cl. B25C 1/00; B25C 1/04; B25C 1/06

(52) U.S. Cl. CPC B25C 1/008; B25C 1/06; B25C 1/04

(57) ABSTRACT

The invention relates to a driving tool for driving fastening means, in particular nails or staples, into a workpiece, a trigger lever, which can be actuated manually, and a workpiece contact element, which can be actuated by placing the driving tool onto the workpiece, being provided, the driving tool being able to operate in a single shot mode, in which each individual sequence of an actuation of the workpiece contact element with subsequent actuation of the trigger lever triggers a driving-in cycle, the driving tool being able to operate in a bump firing mode, in which, with the trigger lever continuously actuated, each individual actuation of the workpiece contact element triggers a driving-in cycle, a resetting assembly being provided, by means of which the driving tool can be reset from the bump firing mode into the single shot mode in an automatic, time-controlled resetting operation. It is proposed that a signaling assembly, which emits a feedback signal to the user before, after or during each automatic resetting operation, is provided.

The present invention relates to a driving tool for driving fastening means into a work-piece according to the preamble of claim 1 and to a method for operating such a driving tool according to the preamble of claim 15.

The driving tool in question is used primarily as a handheld tool, for example for fastening particle boards on supporting structures. The term “fastening means” should be understood here in a broad sense and comprises not only nails and staples but also screws, pins or the like. The main focus of attention here is on the driving in of nails, which should not be understood as being restrictive.

The fastening means usually take the form of a magazine belt. Depending on the design, the magazine belt may for example have a carrier belt of plastic or metal, which carries the individual fastening means. Another variant is that of providing a series of parallel running fastening wires, which are tacked on to the individual fastening means.

The driving tool in question may be designed as a compressed--air-operated driving tool, as a combustion-powered driving tool or as an electrically operated driving tool or the like.

The known driving tool (U.S. Pat. No. 6,604,664 B2), on which the invention is based, is designed as a compressed-air-operated driving tool. It is provided with a pneumatic actuator unit, which serves for driving in the fastening means in individual driving-in cycles.

For triggering the driving-in cycles of the actuator unit, a triggering assembly is provided, having a trigger lever that can be actuated manually and a workpiece contact element that can be actuated by placing the driving tool onto the workpiece.

What is advantageous about the known driving tool is the fact that it can be operated in two different operating modes. In the single shot mode, each individual sequence of an actuation of the workpiece contact element (from the unactuated state of the workpiece contact element) with subsequent actuation of the trigger lever (from the unactuated state of the trigger lever) triggers a driving-in cycle. In the bump firing mode, with the trigger lever continuously actuated, each individual actuation of the workpiece contact element (in each case from the unactuated state) triggers a driving-in cycle

In the case of the known driving tool, a resetting from the bump firing mode into the single shot mode is provided in an automatic, time-controlled resetting operation. For this, the driving tool has a resetting assembly with a control volume. The resetting assembly can be activated in the bump firing mode, by air at a working pressure being admitted into the control volume. The control volume is provided with an air-venting opening, which allows slow venting of the air. If the pressure goes below a limit value, this has the effect after a predetermined delay time of transferring the driving tool into the single shot mode. A separate valve, the valve piston of which is coupled to the workpiece contact element, is provided for the activation of the resetting assembly. An actuation of the work-piece contact element consequently leads to an activation of the resetting assembly. This is intended to achieve the effect that, when the driving tool is not used over a certain delay time, there is a correspondingly automatic, time-controlled resetting of the driving tool from the bump firing mode into the single shot mode in a resetting operation.

The invention addresses the problem of designing and developing the known driving tool in such a way that user convenience with regard to the automatic resetting operation is further increased.

The above problem is solved in the case of a driving tool according to the preamble of claim 1 by the features of the characterizing part of claim 1.

Essential to this is the fundamental consideration that informing the user about a resetting operation that is pending, is in progress or has taken place, which of course takes place in a time-controlled manner and to that extent automatically, leads to an increase in user convenience. For example, this makes it possible to avoid the situation in which the user places the driving tool onto a tool, with the trigger lever actuated, after the automatic resetting operation has already taken place. To be precise, this would have the effect, surprisingly for the user, that the placing of the driving tool, and the associated actuation of the workpiece contact element, would not be accompanied by a fastening means being driven in, since the driving device is already in the single shot mode.

It is specifically proposed that a signaling assembly, which emits a feedback signal to the user before, after or during each automatic resetting operation, is provided. In the simplest case, the feedback signal makes the user aware that the resetting operation is taking place or has already taken place. On this basis, the user can decide whether to continue operating in single shot mode or to transfer the driving tool to bump firing mode.

In a preferred alternative as claimed in claim 3, the signaling assembly emits a feedback signal at a predetermined time interval before the automatic resetting operation. In this way, the user can as it were be warned that the resetting operation is pending. The user can then decide for example to start a further driving-in cycle, in order to remain in bump firing mode.

The feedback signal that can be emitted by the signaling assembly may preferably be an optical signal (claim 7), an acoustic signal (claim 8) or a haptic signal (claims 9 to 11). A combination of these various types of signal is also conceivable.

According to a further teaching as claimed in claim 15, which is likewise of independent significance, a method for operating the driving tool explained above is claimed

What is essential according to this further teaching is that a signaling assembly explained above, by means of which a feedback signal is emitted to the user before, after or during each resetting operation, is provided. Reference may be made to all of the statements made in relation to the operation of the driving tool as proposed.

The invention is explained in more detail below on the basis of a drawing that merely shows exemplary embodiments. In the drawing:

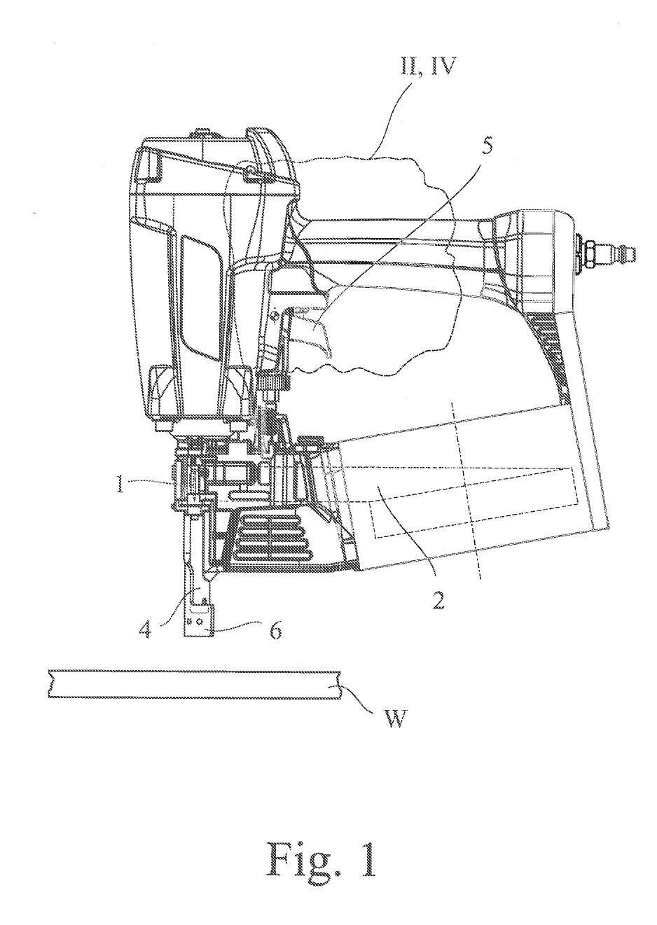

FIG. 1 shows a driving tool as proposed, in a side view,

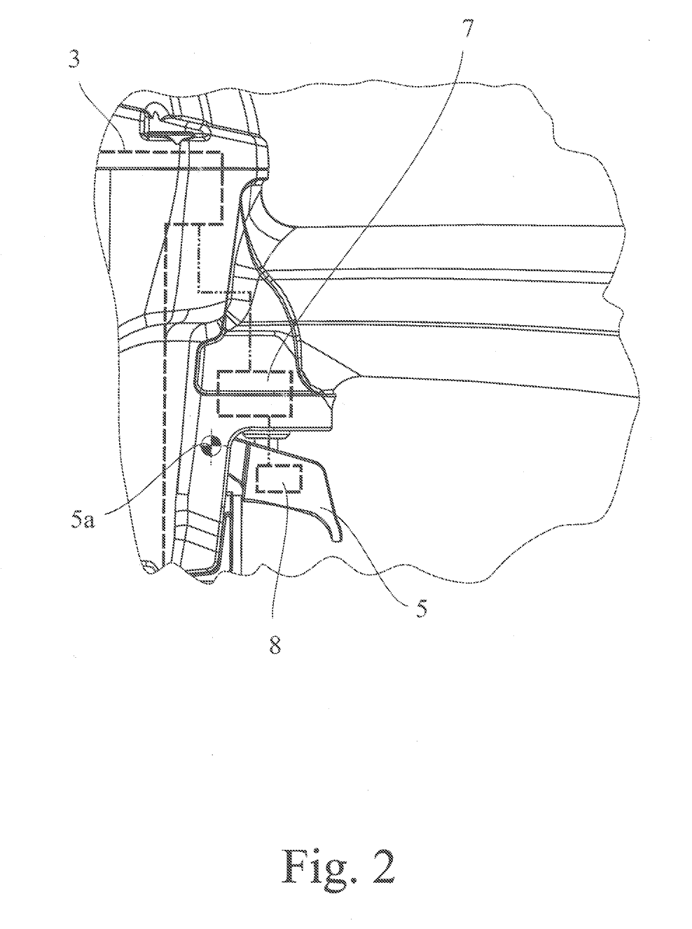

FIG. 2 shows the driving tool according to FIG. 1, in the view of a detail H,

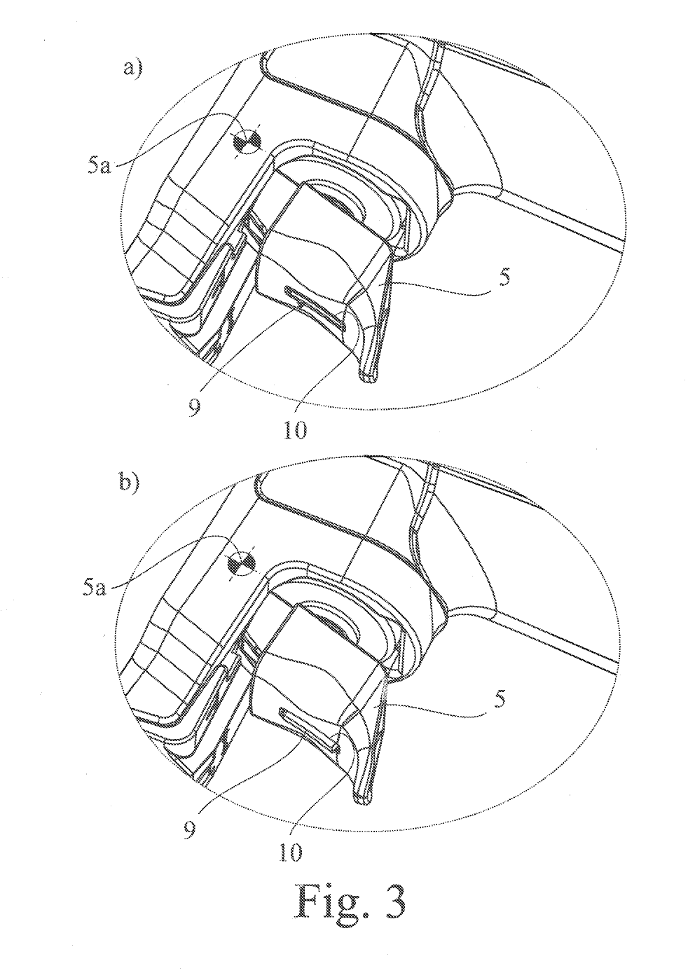

FIG. 3 shows the trigger lever of the driving tool according to FIG. 1 a) in the actuated state without the feedback signal from the signaling assembly and b) in the actuated state with the feedback signal from the signaling assembly and

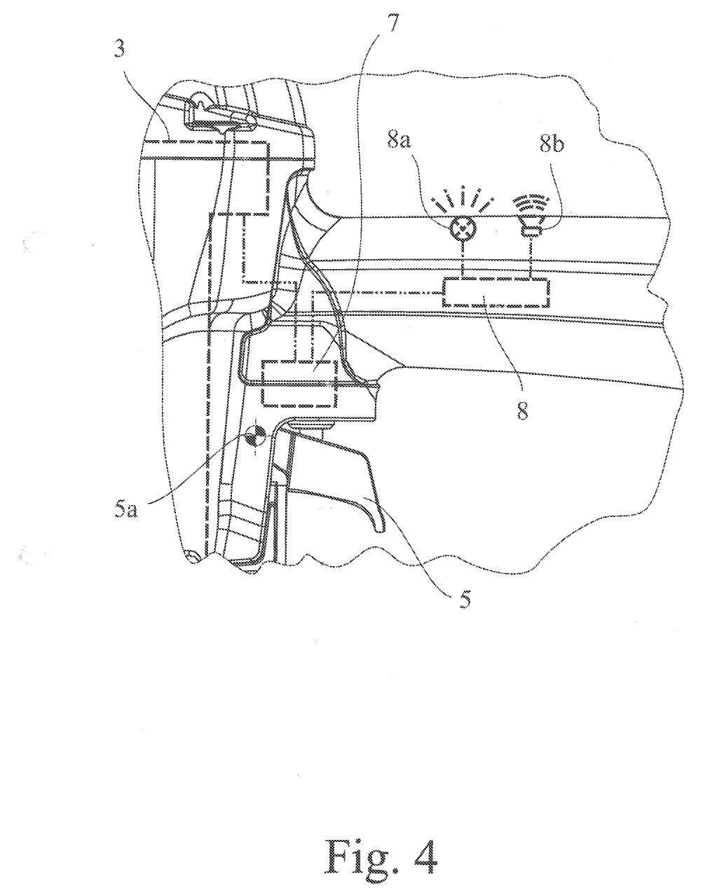

FIG. 4 shows a driving tool according to FIG. 1 in a further embodiment, in the view of a detail IV.

The driving tool that is represented in the drawing serves for driving in fastening means 1 of a magazine belt 2 indicated in FIG. 1, in particular nails, staples or the like. With regard to further interpretation of the term “fastening means”, reference may be made to the introductory part of the description.

The driving in of nails is the main focus of attention in the description that follows, which should not be understood as being restrictive. All statements that are made with respect to nails apply correspondingly to all other types of fastening means that can be driven in.

The driving tool is a compressed-air driving tool with a pneumatic actuator unit 3 schematically represented in the drawing, by means of which the fastening means 1 can be driven into the workpiece W in driving-in cycles. In a driving-in cycle, the fastening means 1, driven by the actuator unit 3, pass through a driving channel 4 into the workpiece W.

The driving tool as proposed also has a trigger lever 5, which can be actuated manually. The trigger lever 5 represented in the drawing can be pivoted about a trigger lever axis 5a for actuation.

In order to avoid unintentional triggering of driving-in cycles, also provided is a work-piece contact element 6, which can be actuated by the placing of the driving tool onto the workpiece W, that is to say by the placing of the workpiece contact element 6 onto the workpiece W. The workpiece contact element 6 can be resiliently deflected upward in FIG. 1 for actuation.

The driving tool can be operated in different operating modes, depending on the application. Firstly, the driving tool can be operated in a single shot mode, in that each individual sequence of an actuation of the workpiece contact element 6 with subsequent actuation of the trigger lever 5 triggers a driving-in cycle. In the single shot mode, the user therefore first places the driving tool onto the workpiece W, thereby actuating the workpiece contact element 6, and subsequently actuates the trigger lever 5. This sequence leads to the triggering of the driving-in cycle.

If the fastening means are to be driven in at a multiplicity of driving-in locations lying next to one another, the driving tool can be advantageously operated in bump tiring mode. In bump firing mode, with the trigger lever 5 continuously actuated, each individual actuation of the workpiece contact element 6 triggers a driving-in cycle. If the user keeps the trigger lever 5 actuated, the placing of the driving tool, and consequently the actuation of the workpiece contact element 6, is sufficient for the triggering of a driving-in cycle.

It is preferably the case that the completely unactuated driving tool is initially in the single shot mode. This means that, for triggering the first driving-in cycle, first the work-piece contact element 6 and then the trigger lever 5 must be actuated. After this first driving-in cycle, the driving tool is preferably in the bump firing mode. The user then has the possibility of keeping the trigger lever 5 actuated and triggering a further driving-in cycle with each actuation of the workpiece contact element 6.

The handling of the driving tool as proposed is made particularly convenient by providing a resetting assembly 7 that is schematically represented in the drawing, by means of which the driving tool can be reset from the bump firing mode into the single shot mode in an automatic, time-controlled resetting operation. This means that such a resetting operation is automatically initiated in accordance with a certain specification, on the basis of a time control, for example on the basis of a specific time sequence. Correspondingly, the resetting assembly 7 is provided with a time-control device of some kind or other.

It is therefore essential to provide a signaling assembly 8, which is likewise only schematically represented in the drawing and which emits a feedback signal to the user before, after or during each automatic resetting operation that is initiated by the resetting assembly 7. Consequently, depending on the design, it is possible for the user to be informed simply as to whether an automatic resetting operation is pending, has already taken place or is in the process of taking place.

Numerous advantageous variants are conceivable for the structural design of the resetting assembly 7. It is preferably the case that the resetting assembly 7 can be activated in the bump firing mode and, after a delay time starting from the activation, has the effect of automatically transferring the driving tool from the bump firing mode into the single shot mode.

The activation of the resetting assembly 7 is possible in various ways. Here and preferably, the resetting assembly 7 is coupled to an actuator unit 3, by means of which the fastening means 1 can be driven into the workpiece W in driving-in cycles, a driving-in cycle activating the resetting assembly 7 in bump firing mode. It may alternatively be provided that the resetting assembly 7 can be activated by a predetermined actuation of the trigger lever 5 and/or of the workpiece contact element 6, for example by the workpiece contact element 6 coming away from a workpiece W.

To sum up, an automatic resetting operation preferably takes place after a delay time starting from the last driving-in cycle or after a delay time starting from the last user actuation and directed at triggering a driving-in cycle.

In principle, it may be provided that signaling assembly 8 emits a feedback signal during every resetting operation that is initiated by the resetting assembly 7. This makes it clear to the user that the driving tool has been reset to the single shot mode. In the case of a particularly preferred design, it is however the case that the signaling assembly 8 emits a feedback signal at a predetermined time interval before the resetting operation. This allows the user to respond, for example in that, with the trigger lever 5 actuated, he actuates the workpiece contact element 6 and thereby triggers a further driving-in cycle. Consequently, the resetting assembly 7 described above involves renewed activation of the resetting assembly 7, and so the driving tool at first remains in the bump firing mode.

Alternatively or in addition, it may be provided that the signaling assembly 8 emits a feedback signal at a predetermined time interval after the resetting operation. This would inform the user that the resetting operation has been safely completed.

Depending on the application, it may also be advantageous that the signaling assembly 8 emits a differing feedback signal, depending on the time interval from the resetting operation. For example, the signaling assembly 8 could emit a cyclical signal, the cycle time of which is continuously reduced as the resetting operation approaches.

A particularly low-cost structure can be achieved by the signaling assembly 8 being operated electrically. Numerous electrically operated variants for the emission of a feedback signal are known.

In a particularly preferred design, the driving tool is operated electrically, the signaling assembly 8 being operated by the voltage supply of the driving tool. Alternatively, the signaling assembly 8 may also be assigned a separate voltage supply, in particular a battery assembly or the like.

It is also advantageous that the signaling assembly 8 is operated pneumatically. This is advantageous in particular if the driving tool itself is operated pneumatically, the signaling assembly 8 preferably relying on the compressed air supply of the driving tool.

Depending on the application, completely different variants are conceivable for the feedback signal of the signaling assembly 8. For example, the feedback signal may be an optical signal (FIG. 4). It is then preferably the case that the signaling assembly 8 has a corresponding light source 8a. The light source 8b may be, for example, a light-emitting diode assembly or the like. Alternatively, the signaling assembly 8 may have a mechanical display. For example, the signaling assembly 8 may have a display element, in particular a colored display element, which can be presented in a display window.

Alternatively or in addition, however, it may also be the case that the feedback signal that can be emitted by the signaling assembly 8 is an acoustic signal, the signaling assembly preferably having for this a sound generator 8b (FIG. 4). Such a sound generator may be an electrical buzzer, an electrical loudspeaker, a pneumatic whistling assembly or the like.

In a particularly preferred design, however, it is the case that the feedback signal that can be emitted by the signaling assembly 8 is a haptic signal (FIGS. 1-3). In this case, the signaling assembly 8 preferably has a signaling movement drive for generating a tangible signaling movement, a signaling pulse generator for generating a tangible signaling pulse or a signaling vibrator for generating a tangible signaling vibration.

The above, haptic signals of the signaling assembly 8 can be felt best by the user when the signaling assembly 8 is at least partly integrated in the trigger lever 5.

The signaling assembly 8 advantageously has a feeling element 9, which can be adjusted for the emission of a haptic feedback signal and can be seen in the representation according to FIG. 3. In this case, the feeling element 9 is preferably integrated in the trigger lever 5, as the representation according to FIG. 3 likewise shows. In the case of the exemplary embodiment represented in FIG. 3, the feeling element 9 is adjustable with respect to the trigger lever 5 for the emission of the haptic feedback signal. Specifically, the trigger lever 5 forms a receptacle for the feeling element 9, the feeling element 9 protruding through an opening 10 in the trigger lever 5, at least for the emission of a feedback signal. This is evident from viewing FIGS. 3a) and 3b) together. In FIG. 3a), the signaling assembly 8 is not yet emitting a feedback signal. In FIG. 3b), the signaling assembly 8 is emitting a feedback signal, in that the feeling element 9 is made to project through the slit-like opening 10 in the trigger lever 5. For this, the feeling element 9 is preferably coupled to an aforementioned signaling movement drive.

A particularly simple structure is obtained, however, by the signaling assembly 8 being a component part of the resetting assembly 7, in particular if the signaling assembly 8 serves for generating haptic feedback signals. This is attributable to the consideration that the resetting assembly 7 must in any case implement an adjusting movement of some kind or other for the implementation of the resetting operation, and this can be used for generating the haptic feedback signals.

Specifically, the resetting assembly 7 is preferably provided with a resetting element, which is adjusted into a resetting position for the resetting of the driving device into the single shot mode, the adjustment of the resetting element into the resetting position being triggered by generation of the feedback signal. The adjustment of the resetting element into the resetting position preferably brings about a corresponding adjustment of the feeling element 9, here and preferably through the slit-like opening 10 in the trigger lever 5, as a feedback signal.

According to a further teaching, which is of independent significance, a method for operating a driving tool as proposed is claimed.

The driving tool correspondingly has a trigger lever 6, which can be actuated manually, and a workpiece contact element 7, which can be actuated by placing the driving tool onto the workpiece W, and can be operated in a single shot mode and in a bump firing mode. Also provided is a resetting assembly 7, by means of which the driving tool is reset from the bump firing mode into the single shot triode in a time-controlled resetting operation.

What is essential according to the further teaching is that a signaling assembly 8 is provided, by means of which a feedback signal is emitted to the user before, after or during every resetting operation. Reference may be made to all of the statements made with respect to the operation of the driving tool as proposed.

1. A driving tool for driving fastening means, in particular nails or staples, into a workpiece, a trigger lever, which can be actuated manually, and a workpiece contact element, which can be actuated by placing the driving tool onto the workpiece, being provided, the driving tool being able to operate in a single shot mode, in which each individual sequence of an actuation of the workpiece contact element with subsequent actuation of the trigger lever triggers a driving-in cycle, the driving tool being able to operate in a bump firing mode, in which, with the trigger lever continuously actuated, each individual actuation of the workpiece contact element triggers a driving-in cycle, a resetting assembly being provided, by means of which the driving tool can be reset from the bump firing mode into the single shot mode in an automatic, time-controlled resetting operation, characterized in that a signaling assembly, which emits a feedback signal to the user before, after or during each automatic resetting operation, is provided.

2. The driving tool as claimed in claim 1, wherein, the resetting assembly can be activated in the bump firing mode and, after a delay time starting from the activation, has the effect of transferring the driving tool from the bump firing mode into the single shot mode, preferably in that the resetting assembly is coupled to an actuator unit, by means of which the fastening means can be driven into the workpiece in driving-in cycles, in such a way that a driving-in cycle activates the resetting assembly in bump firing mode, or in that the resetting assembly can be activated by a predetermined actuation of the trigger lever and/or of the workpiece contact element, in particular by the workpiece contact element coming away from a workpiece.

3. The driving tool as claimed in claim 1, the signaling assembly emits a feedback signal at a predetermined time interval before and/or after the automatic resetting operation.

4. The driving tool as claimed in claim 1, wherein the signaling assembly emits a differing feedback signal, depending on the time interval from the automatic resetting operation.

5. The driving tool as claimed in claim 1, wherein the signaling assembly is operated electrically, preferably in that the driving tool is operated electrically and the signaling assembly is operated by the voltage supply of the driving tool, or in that the signaling assembly is assigned a separate voltage supply, in particular a battery assembly.

6. The driving tool as claimed in claim 1, wherein the signaling assembly is operated pneumatically, preferably in that the driving tool is operated pneumatically and in that the signaling assembly is operated by the compressed-air supply of the driving tool.

7. The driving tool as claimed in claim 1, wherein the feedback signal that can be emitted by the signaling assembly is an optical signal, preferably in that the signaling assembly has for this a light source, or in that the signaling assembly has a mechanical display.

8. The driving tool as claimed in claim 1, wherein the feedback signal that can be emitted by the signaling assembly is an acoustic signal, preferably in that the signaling assembly has for this a sound generator.

9. The driving tool as claimed in claim 1, wherein the feedback signal that can be emitted by the signaling assembly is a haptic signal, preferably in that the signaling assembly has for this a signaling movement drive for generating a signaling movement, a signaling pulse generator for generating a signaling pulse or a signaling vibrator for generating a signaling vibration.

10. The driving tool as claimed in claim 1, wherein the signaling assembly is at least partly integrated in the trigger lever.

11. The driving tool as claimed in claim 1, wherein the signaling assembly has a feeling element, which can be adjusted for the emission of a haptic feedback signal, preferably in that the feeling element is integrated in the trigger lever, more preferably in that the feeling element is adjustable with respect to the trigger lever for the emission of the haptic feedback signal.

12. The driving tool as claimed in claim 1, wherein the signaling assembly is a component part of the resetting assembly.

13. The driving tool as claimed in claim 1, wherein the resetting assembly has a resetting element, which is adjusted into a resetting position for the resetting of the driving device into the single shot mode, and in that the adjustment of the resetting element into the resetting position is triggered by generation of the feedback signal.

14. The driving tool as claimed in claim 13, wherein the adjustment of the resetting element into the resetting position brings about an adjustment of the feeling element as a feedback signal.

15. A method for operating a driving tool, in particular a driving tool as claimed in 1, for driving fastening means, in particular nails or staples, into a workpiece, a trigger ever, which can be actuated manually, and a workpiece contact element, which can be actuated by placing the driving tool onto the workpiece, being provided, the driving tool being able to operate in a single shot mode, in which each individual sequence of an actuation of the workpiece contact element with subsequent actuation of the trigger lever triggers a driving-in cycle, the driving tool being able to operate in a bump firing mode, in which, with the trigger lever continuously actuated, each individual actuation of the workpiece contact element triggers a driving-in cycle, a resetting assembly being provided, by means of which the driving tool is reset from the bump firing mode into the single shot mode in an automatic, time-controlled resetting operation, characterized in that a signaling assembly, by means of which a feedback signal is emitted to the user before, after or during each automatic resetting operation, is provided.
